(19) United States
(12) Patent Application Publication
(10) Pub. No.: US 2014/0033004 A1
(43) Pub. Date: Jan. 30, 2014

(54) VISUALIZATION OF A PACKAGED FILE

(71) Applicant: Vivek Hebbar, Cupertino, CA (US)

(72) Inventor: Vivek Hebbar, Cupertino, CA (US)

(73) Assignee: Adobe Systems Incorporated, San Jose, CA (US)

(21) Appl. No.: 12/756,798

(22) Filed: Apr. 8, 2010

(51) Int. Cl. G06F 3/14; G06F 17/00

(52) U.S. Cl. 715/202; 715/205

(57) ABSTRACT

Various embodiments herein provide at least one of systems, methods, and software for visualization of content files within a package file. A package file is a data file that includes other files stored therein. Some embodiments include authoring a package file by adding a content file to the package file and associating the added content file with a data visualizer. When the content file is selected for viewing from the package file, the data visualizer associated with the content file is used to provide a view of data within the content file. Other embodiments are directed to viewing a content file of a package file utilizing an associated data visualizer.

### BACKGROUND INFORMATION

Electronic documents (e.g., page description language documents) and other electronic content have become increasingly pervasive as the use of electronic computer systems and networks (e.g., the Internet) have grown. Increasingly, collections or bundles of electronic content are being generated and made available on electronic computer systems.

Such collections or bundles of electronic content are usually groups of content files within a container or package file. As used herein, container and package files, and other like names, will be referred to as package files, unless otherwise specified. The package file may be a compressed archive (e.g., a ZIP file) or other file types within which content files may be embedded (e.g., word processing files, page description language documents).

When a content file within a package file is selected for viewing, the content file is either presented with a generic file view of a computer program presenting a view of the package file or through another computer program on the computer upon which the computer program is executing. This other computer program is used in such instances by making a file open call to an operating system, which identifies the proper program which then opens the content file.

### BRIEF DESCRIPTION OF THE DRAWINGS

FIG. 1 is a user interface illustration, according to an example embodiment.

FIG. 2 is a user interface illustration, according to an example embodiment.

FIG. 3 is a user interface illustration, according to an example embodiment.

FIG. 4 is a user interface illustration, according to an example embodiment.

FIG. 5 is a pseudo code listing of a page description language document, according to an example embodiment.

FIG. 6 is a block diagram of logical portions of a system, according to an example embodiment.

FIG. 7 is a block diagram of logical portions of a system, according to an example embodiment.

FIG. 8 includes block diagrams of various page description language documents, according to example embodiments.

FIG. 9 is a flow diagram of a method, according to an example embodiment.

FIG. 10 is a flow diagram of a method, according to an example embodiment.

FIG. 11 is a flow diagram of a method, according to an example embodiment.

FIG. 12 is a block diagram of a computing device, according to an example embodiment.

FIG. 13 is a logical diagram of a computing environment, according to an example embodiment.

### DETAILED DESCRIPTION

Collections or bundles of electronic content files may be packaged into a container file. As used herein, container and package files, and other like names, are referred to as package files, or even simply as a package, unless otherwise specified. A package file may be a compressed archive (e.g., a ZIP file) or other file types within which content files may be embedded (e.g., word processing files, page description language documents). Package files may be presented in package file presentations applications. A package file presentation application is an application capable of presenting a view of a package file, such as an application capable of presenting a view of compressed files within a ZIP archive, the ADOBE® ACROBAT® program available from ADOBE SYSTEMS INCORPORATED of San Jose, Calif., when the package file is a PDF document, and other applications.

A listing of files contained within a package file may be presented by package file presentation applications in a number of ways, such as through a simple file listing or through an elaborate presentation specification. For example, considering page description language documents, simple lists or links for each content file of a package file may be presented within page description language documents, such as PDF documents. In other instances, package files may provide more interactive ways to author and present package files, such as through a presentation specification. For example, content listing mechanisms may provide rich descriptions, and even graphical representations, of content files within a package, allowing a viewer to identify if particular content files are relevant for a particular need without even opening the particular content files. Some embodiments may allow a viewer to select a mode of presentation of a packaged file. Some embodiments allow content authors to include graphics, audio, moving images and videos, and views of package files within a presentation specification to provide graphical representations of content files included in package files. As an ancillary benefit, presentation specifications may be utilized to include branding information, such as company logos, information, product illustrations, and the like in an interactive presentation.

A presentation specification may provide a view of a collection or group (e.g., package) of content files in a user interface using a customizable navigation template, which is referred to herein as a presentation specification. A presentation specification may be an object adapted to present one or more views of a package file. The views presented by a presentation specification may be user interactive and may include any of still images, animations, video, audio, and other forms of media. A presentation specification may include unique package branding (e.g., a package of files delivered by a company may be branded using that company's branding). Presentation specifications may be supported by the creation and visualization of metadata regarding the content files included in a package file. For example, the content file metadata may be automatically determined, such as file type, creation date, length etc., or it may also be user-inputted, such as commentary and notes regarding the package as a whole or the individual content files included therein. The metadata may also be independently added to a package file or content files packaged within the package file.

Multiple presentation specifications may also be defined for a common package file. In addition, presentation specifications may be made available for package file views. For example, a particular company may publish a number of presentation specifications for various package files that are typically assembled by that organization, each of these presentation specifications including a custom navigation template and organization-specific branding.

Package files may be authored in several ways. For example, a user may be provided with user interfaces that may be manipulated to author a package file. Such user interfaces may also provide the user with mechanisms to set various options, to define metadata, and to attach or otherwise associate content files with a package, such as via linking to content files accessible over a network. Other mechanisms may also be provided that may be used in a drag-and-drop fashion where a user may select content files to be packaged, such as in a file explorer-type user interface of an operating system, and drag-and-drop the content files into a package file user interface item, such as an icon. In some instances, the user may also select one or more presentation specifications for use in displaying representations of the content file.

The authoring and presentation of package files described thus far is performed to provide a view of what files are contained within a package file. When a content file is selected from a presentation of a package file, a selection of a content file made through selection input such as a double-click of a mouse, a touch on a touch screen, or other input from an input device, the selected content file is typically presented. The presentation of the content file is made through a generic file viewer of and included in a computer application presenting the view of the package file. In other instances, the selected content file, or a reference thereto, is passed to an operating system with a file open command. The operating system then processes the command to open the content file.

Regardless of whether the package file is presented through a rudimentary file listing user interface or an elaborate presentation specification, when a content file is selected for viewing, there is no guarantee that a view of the file can be provided as a package file may contain a file of a type that is not supported by an application installed on the computer upon which the package file is being viewed. Further, even when a view of the selected content file can be provided, the author of the content file or the package file may desire to control how the selected content file is presented. To address such issues, to increase file display options, and provide additional functionality options, some embodiments include data visualizers that may be associated with and be used to present a view of a content file.

In some embodiments, a data visualizer may be added to a package file, either directly or as a reference to a network location from which the data visualizer may be downloaded. The data visualizer may be associated with one or more content files within metadata of a package file. Thus, when input is received within a package file presentation application selecting a content file to be viewed, the package file presentation application determines if the content file is associated with a data visualizer. If so, the package file presentation application retrieves the data visualizer, forms the file or other location identified in metadata, instantiates the data visualizer through an application programming interface of the package file presentation application or an application plug-in, and presents a view of the content file through the data visualizer.

A data visualizer may include executable code that implements functionality. In some embodiments, the code is in a runtime scripting language, such as Java Script, Visual Basic (VB) Script, Action Script, and the like. Such code allows data visualizer author to add scripting and code to data visualizers to implement functionality and customize how a content file may be presented. Such code may be executable within an application or application plug-in, such as the FLASH® Player application plug-in available from ADOBE SYSTEMS INCORPORATED of San Jose, Calif., or other applications or application plug-ins. In other embodiments, the code is compiled code written in a language, such as C/C++, capable of implementing the desired functionality, which may be accessed and executed within or caused to be executed by an application within which a package file is viewed.

Data visualizers are distinct from presentation specifications. A data visualizer provides a view of the data of a content file included in a package file as opposed to a presentation specification, which provides a view of data descriptive of content files included in a package file and different ways to easily navigate through the view of content files included in the package file. Further, a presentation specification includes executable instructions and data to provide a view of content files included in a package file but does not include executable instructions and data to present a view of the data of a content file. Conversely, a data visualizer does not include executable instructions and data to provide a view of content files included in the package file but does include executable instructions to present a view of a content file. These and other embodiments are described below with reference to the drawings.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. The following description is, therefore, not to be taken in a limited sense, and the scope of the inventive subject matter is defined by the appended claims.

The functions or algorithms described herein are implemented in hardware, software, or a combination of software and hardware in one embodiment. The software comprises computer-executable instructions stored on computer-readable medium such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC (application-specific integrated circuit), microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

Some portions of this description are presented in terms of algorithms or symbolic representations of operations on data bits or binary digital signals stored within a memory device of a computer, such as a computer memory. These algorithmic descriptions or representations are examples of techniques used by those of ordinary skill in the data processing arts to convey the substance of their work to others skilled in the art. An algorithm here, and generally, is considered a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

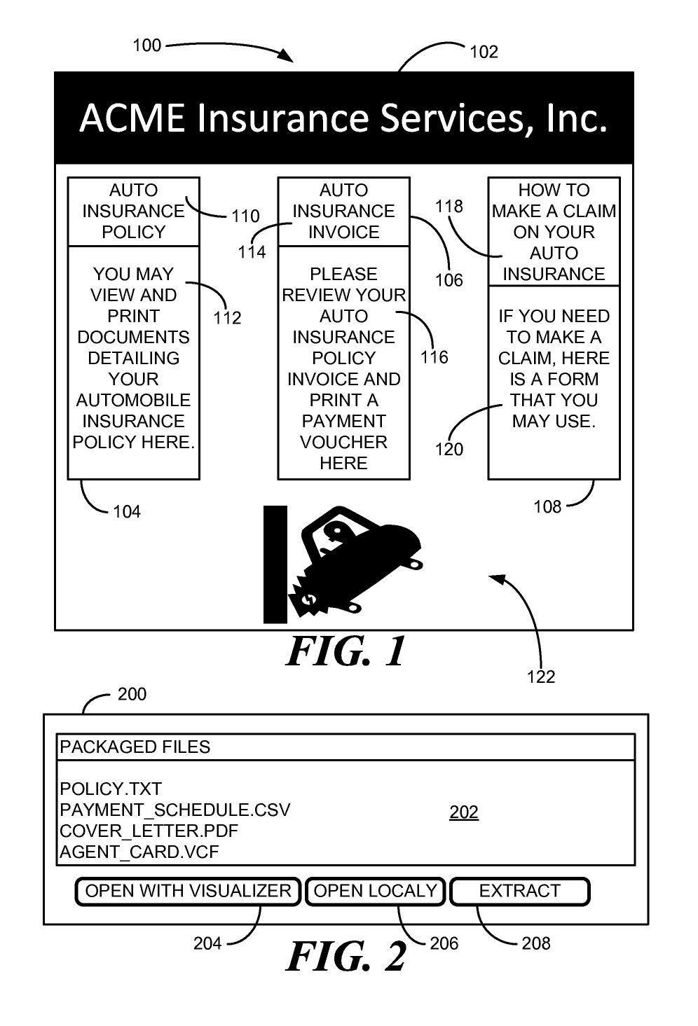

FIG. 1 is a user interface 100 illustration, according to an example embodiment. The user interface 100 illustrates a view of a package file presented according to a presentation specification. The view of the package file includes a representation of three content files created for a recipient. The presentation specification, when instantiated in the user interface 100, may include elements such as a header 102, a body including three columns 104, 106, 108, and a footer including an image 122. The package file, in some embodiments, is a page description language document, such as a PDF document.

The header 102, in this embodiment, includes a graphic of an entity (e.g., company, organization, or person) of origin of the package file. The graphic is instantiated from an image file that may also be packaged within the package file. However, in some embodiments, the image file may be referenced by an Internet address in metadata of the presentation specification. Thus, in the event the entity of origin modifies its image file, an updated image file may be stored to the Internet address and subsequent views of the package file using the presentation specification will display the modified image file.

The columns 104, 106, 108 of the body portion of the user interface 100 include a column for each of three content files, such as documents, included in the package file. The columns, in the example embodiment, each include a title 110, 114, 118 and a description 112, 116, 120. The titles and descriptions provide information to a viewer about a content file that may be viewed by selecting a respective column 104, 106, 108. For example, a user may desire to view information regarding the user's auto insurance policy. The user in such an example would select the left most column 104, such as by clicking a mouse on the column 104. Such a selection, in some embodiments, may cause the underlying content file to be displayed.

The metadata of the presentation specification, of the package file, or of the content file underlying the selected left most column 104 may specify a data visualizer for use in displaying the content file. In such embodiments, upon receipt of a selection of a representation of a content item, such as the left most column 104, the specified data visualizer will be retrieved and instantiated and the content file will be opened and displayed within the instantiated data visualizer. The data visualizer may be specified by a reference to a file included in the package file or a reference to a network location from which the data visualizer may be retrieved. The reference to a network location may be a Universal Resource Identifier (URI), such as a Universal Resource Locator (URL), a network drive and folder where the data visualizer is stored, or other network location.

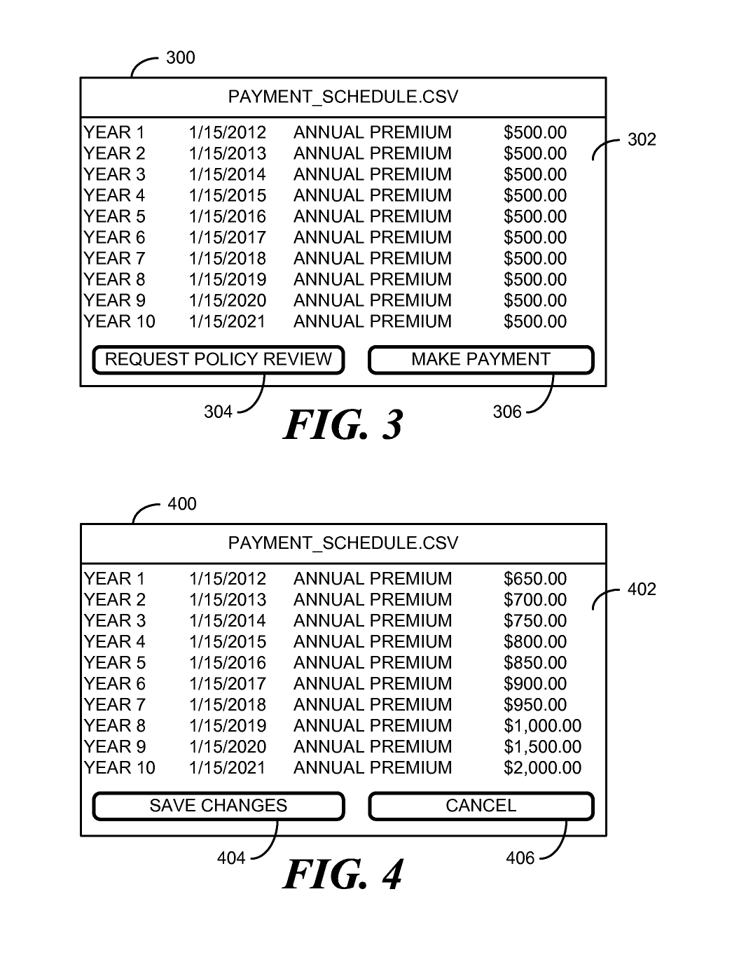

FIG. 2 is a user interface 200 illustration, according to an example embodiment. The user interface 200 illustrates a view of a package file presented as a simple file listing 202 of files included in the package file. The user interface 200 receives input selecting one or more of the files provided in the file listing 202. Following selection of one or more of the files in the file listing 202, a user may then select an action button to perform an action with regard to the one or more selected files. The action buttons include an OPEN WITH VISUALIZER action button 204, the selection of which will open a selected content file with a data visualizer associated therewith in metadata of the package file or metadata of the selected file. For example, when the PAYMENT_SCHEDULE.CSV content file is selected within the file listing and input is received into the user interface 200 selecting the OPEN WITH VISUALIZER action button 204, a data visualizer as referenced in metadata of the package file is retrieved and a view of the PAYMENT_SCHEDULE.CSV content file is presented. The view of the PAYMENT_SCHEDULE.CSV content file is presented through the retrieved data visualizer, such as is illustrated and described with regard to the embodiments of FIG. 3 and FIG. 4.

In some embodiments, the data visualizer may alternatively be included in a presentation specification. In such embodiments, the OPEN WITH VISUALISER action button 204, when selected, may cause a data visualizer to be identified in metadata or instructions of a presentation specification. The data visualizer may then be retrieved from the data of the presentation specification or from a network location identified in the presentation specification. The selected file will then be presented in the retrieved data visualizer.

The user interface 200 provides two additional action buttons. One of these action buttons is an OPEN LOCALLY action button 206, which upon selection sends an open file command to an operating system of a computer providing a view of the user interface 200 to open the one or more selected files of the file listing 202 utilizing programs that are present on the computer. The other action button is an EXTRACT action button 208, which upon selection provides an additional user interface to allow a user to specify where to store a copy of one or more documents selected within the file listing 202.

The user interfaces 100, 200 of FIG. 1 and FIG. 2 are examples of user interfaces according to some embodiments. Such user interfaces may include more elements, fewer elements, and even different elements. However, such user interfaces provide representations of content files included in a package file being view in the user interface.

FIG. 3 is a user interface 300 illustration, according to an example embodiment. The user interface 300 is an example of a data visualizer that presents a view of a content file included in a package file. The user interface 300 provides a view of the content file PAYMENT_SCHEDULE.CSV as illustrated in the file listing 202 of the user interface 200 of FIG. 2. The user interface 300 includes a display area 302 that provides a view of data included in the content file. The user interface 300 also includes a REQUEST POLICY REVIEW action button 304 and a MAKE PAYMENT action button 306. Selection of these action buttons 304, 306 will cause code underlying the respective action button to be executed. For example, the selection of the REQUEST POLICY REVIEW action button 304 may cause a message, such as an email, to be sent to an issuer or issuing agent of an insurance policy, data of which is presented in the display area 302, to request a policy review. As a further example, selection of the MAKE PAYMENT action button 306 may cause a call to a URL of a website through which a payment may be made.

Although the data visualizer of the user interface 300 is illustrated with regard to a CSV file-type, data visualizers may be created and used with regard to virtually any file type. However, the particular file type for which a data visualizer is created is customized to that file type. For example, if the file type is an audio/visual file type, such as a video file, the data visualizer may be created with controls to enable playback of the audio/visual data of the file type.

Additionally, as described above, a data visualizer may include executable code that implements functionality, such as the action buttons 304, 306. In some embodiments, the code is in a runtime scripting language, such as Java Script, Visual Basic (VB) Script, Action Script, and the like. Such code allows data visualizer author to add scripting and code to data visualizers to implement functionality and customize how a content file may be presented and actions that may be taken with regard to the content file or with data therein. In some embodiments, a data visualizer may be a SWF file with action script that is presentable and executable within a FLASH® Player application plug-in or application module.

FIG. 4 is a user interface 400 illustration, according to an example embodiment. The user interface 400 is an example of a data visualizer that presents a view of a content file included in a package file and allows editing of the content file and storing of the edits. The user interface 400 provides a view of the content file PAYMENT_SCHEDULE.CSV similarly as in FIG. 3. The user interface 400 includes a display area 402 that provides a view of data included in the content file. The view of the data in the display area 402 is editable. When the editing is complete, a SAVE CHANGES action button 404 can be selected, causing code to execute to save the edits to the data in the display area. Alternatively, a CANCEL action button 406 may be selected, causing code to execute to discard the edits to the data in the display area.

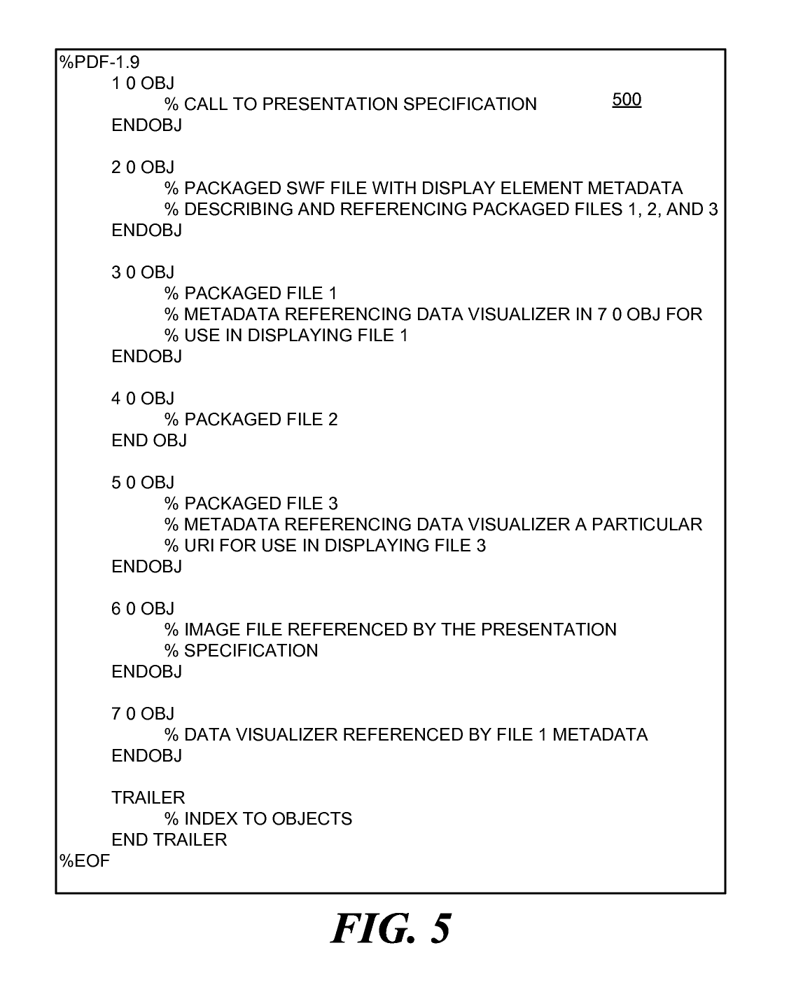

FIG. 5 is a pseudo code listing 500 of a page description language document, according to an example embodiment. The page description language document, in this embodiment, is a package file and includes six files packaged therein. The six packaged files include a presentation specification in 2.0 OBJ, packaged content files 1, 2, and 3 in 2 0 OBJ, 3 0 OBJ, and 4 0 OBJ, respectively, an image file in 6.0 OBJ that is referenced in the presentation specification, 2.0 OBJ, and a data visualizer in 7 0 OBJ. The pseudo code listing 500 in 1 0 OBJ includes a call to a presentation specification, 2.0 OBJ. In some embodiments, when a page description language document includes a presentation specification, the presentation specification is instantiated upon opening the page description language document.

A data structure of a presentation specification that may be included in a package file may include metadata associating each of one or more content files within a page description language document to a presentation display element of the presentation specification. However, in some embodiments, the metadata may define display elements to be instantiated by the presentation specification. A presentation display element may or may not be a hierarchical presentation display element.

In some embodiments, the data structure of the presentation specification may include data defining a package file presentation header to be presented with a content file when selected within a page description language reader application for display. In other embodiments, rather than specifying particular elements to be displayed, metadata associated with a packaged file, such as packaged file 1 in the 3 0 OBJ, may include metadata associating the package file to a data visualizer. That association may be to a data visualizer included in the package file, such as the data visualizer of the 7 0 OBJ. Alternatively, a package file may be associated with a data visualizer retrievable from a network location, such as package file 3 of the 5 0 OBJ. In either of such data visualizer instances, the data visualizer is retrieved, instantiated, and the respective package file is displayed within the instantiated data visualizer.

In some embodiments, the presentation specification also includes instructions executable within an environment of the page description language reader application, or other application depending on the file type of the package file, to cause the presentation specification to be instantiated and displayed within a graphical user interface of the application. In some embodiments, the instructions may also be executable to modify an appearance of the displayed presentation specification in response to one or more events, such as a user clicking a mouse on a display element, a hover event of a mouse over a displayed element, or other event. In some embodiments where the application that provides a view of the package file based on the presentation specification is a page description language reader application, at least one package file, such as package file 1 of the 3 0 OBJ, associated with a data visualizer, such as the data visualizer of the 7 0 OBJ, is of a file type other than a page description language document.

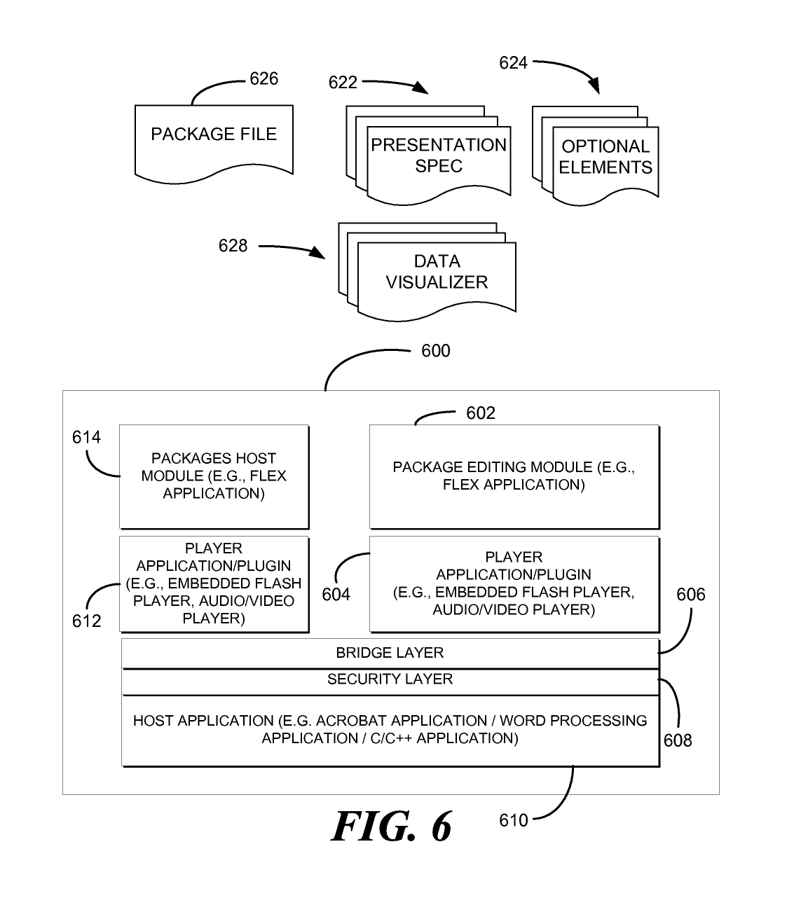

FIG. 6 is block diagram of logical portions of a system, according to an example embodiment. FIG. 6 includes one or more presentation specifications 622, one or more data visualizers 628, and optional elements 624 that may be selected and manipulated utilizing an application 600 to author a package file 626. The application 600, in some embodiments, is a page description language document authoring application that includes additional modules that facilitate authoring of the package file 626, which may include associating files of the package file 626 with a data visualizer 628 for use by the application 600 in presenting a view of the associated files. The further modules may include a package editing module 602, a first player application or plug-in instance 604, a packages host module 614, and a second player application or plug-in instance 612. The first and second player applications or plug-in instances 604, 612 may be identical instances of an application or plug-in, such as the FLASH® Player application plug-in as described above. However, in other embodiments, one or both of the first and second player application or plug-in instances 604, 612 may include one or more other media presentation applications or plug-ins capable of presenting media, such as images, animations, still and moving images, audio, and/or other media formats. Examples of such applications and plug-ins may include SilverLight available from Microsoft Corporation and QuickTime available from Apple, Inc.

The package editing module 602 and the packages host module 614 are applications encoded according to a format of the respective player applications or plug-ins 604, 612 upon which they operate. In some embodiments, the package editing module 602 executes within the player application/plug-in 604 to provide user interfaces that allow a package file 626 author to select one or more presentation specifications 622, associate data visualizers 628 with content files in the package file 626, configure one or more optional elements 624, and to specify properties and enter other data into the package file 626. The packages host module 614 is operable within the player application/plug-in 612 to display the package file 626 and data visualizers 628 in a player mode and in an authoring mode. While in the player mode, the packages host module 614 is operable to allow a user to interact with a displayed package file 626 according to a presentation specification 622 and a content file included in the package file 626 according to a data visualizer 628. While in the authoring mode, the packages host module 614 is operable to reflect changes made to the package file 626 by the package editing module 602.

Changes made to the package file 626 via the package editing module 602 are communicated to the packages host module 614 via a bridge layer 606. The bridge layer 606 may be an interface in the form of an Application Programming Interface (API) that provides mechanisms by which data representative of data within the package file 626 and changes made to the package file 626 may be moved and may flow between the packages host module 614 and the package editing module 602. For example, when the package editing module 602 is used to select one or more of the presentation specifications 622 for inclusion in the package file 626, data representative of a selected presentation specification is included in a bridge layer 606 function or method call which causes a reference to the selected presentation specification to flow to the packages host module 614. However, in other embodiments, a data structure of the selected presentation specification may be passed via the bridge layer 606.

In some embodiments, due to the programmatic nature of the package editing module 602, packages host module 614, presentation specifications 622, optional elements 624, and package file 626, the bridge layer 606 is insulated from a host layer 610 of the application 600. The host layer 610 may include a kernel or at least some portions of application 600. In some embodiments, the insulation of the bridge layer 606 from the host layer 610 is provided by a security layer 608. The security layer 608 may limit access to some resources of the application 600, such as access to files and other resources of and on a computing device upon which the application 600 is present.

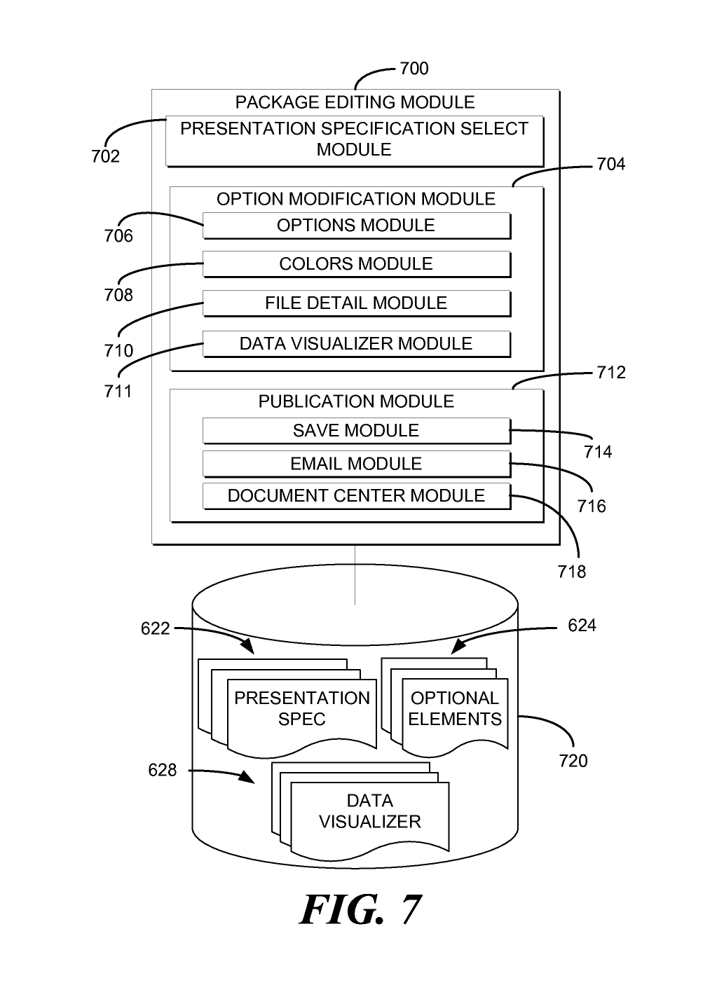

FIG. 7 is block diagram of logical portions of a system, according to an example embodiment. The block diagram of FIG. 7 provides a detailed perspective of a package editing module 700. The package editing module 700 is one example embodiment of the package editing module 602 of FIG. 6. The package editing module 700 is but one example and may include a greater or lesser number of elements and other modules in other embodiments.

The package editing module 700, in some embodiments, includes a presentation specification select module 702, an option modification module 704, and a publication module 712. The presentation specification select module 702 is operative to provide a user interface to allow selection of a presentation specification 622 held in a storage device 720 to which the package editing module 700 has access. The presentation specification select module 702, upon receipt of a presentation specification selection, causes data representative of the selection to be communicated to a package host module, such as the packages host module 614 of FIG. 6.

The option modification module 704, in some embodiments, is operative to present package file authoring options via one or more user interfaces according to one or more further modules. The further modules may include one or more of an options module 706, a colors module 708, a file detail module 710, a data visualizer module 711, and other modules depending on a selected presentation specification, data visualizers, the particular embodiment, permissions of a person using the package editing module 700, and other factors. In some embodiments, the options module 706 is operable to provide package file and presentation specification options to a user. Some such options may include security and encryption options, data compression options, options that modify how a presentation specification is displayed within a package host module, and other options that may apply to a package file as a whole or in part when displayed. In some embodiments, the data visualizer module 711 provides a user with optional data visualizers 628, the ability to associate data visualizers with files within a package file, and options on where to store data visualizers when associated with package files. Such storage locations may be included within the package file and other storage locations accessible over a network, such as the Internet. Some further options may include one or more optional elements 624 from the storage device 720 which may be selected for inclusion in a package file or which may already be included or referenced in a selected presentation specification 622. Such optional elements 624 may include one or more navigation aids that provide navigation functionality within a displayed presentation specification. In some embodiments, the optional elements 624 may include another instance of a media playing application or plug-in which may be configured to play an audio track, display a video, animation, a series of still images, or other media types when displayed. As with the presentation specifications 622, the functionality of the optional elements 624 is generally limited only by the imagination of an optional element developer or package file author.

The colors module 708, in some embodiments, provides one or more user interfaces operable to receive input to define colors used when displaying views of a package file within a presentation specification. The one or more user interfaces, in some embodiments, provide a color palette to select colors from or enter color specifications into, such as red-green-blue (RGB) values. In some embodiments, the colors module 708 is operative to receive a selection of one or more presentation specification elements via a menu item or by user input into the packages host module 614, of FIG. 6, via the bridge layer 606, also of FIG. 6. The colors module 708 is the operative to receive color specification input for the selected elements and to populate the color specification input across the bridge layer 606 to cause the color specification input to be reflected in a view of the package file within the packages host module 614.

In some embodiments, the file detail module 710 is operative to provide one or more user interfaces to allow users to define and manipulate metadata associated with a selected presentation specification and content files within a package file. Such user interfaces may allow a user to add, delete, and modify metadata fields and associate those metadata fields with content files within the package file or to the package file itself. The metadata fields may be designated for display or made invisible. In some embodiments, the metadata fields may be defined to hold descriptions of content files; to hold location (e.g., geospatial) data, such as latitude and longitude, of a location to which each content file is relevant; hold an X, Y coordinate pair mapping to an image location to which each content file is applicable; hold a date to which each content file pertains; and many other metadata types. In some embodiments, the metadata may provide additional functionality possibilities, such as automatic mapping of content files to locations within a reference image or animation, such as a map or calendar, as a function of the metadata.

In some embodiments, the file detail module 710 or other module may also include one or more user interfaces which may be used to view the contents of the storage device 720 or other local and/or remote storage devices. Such user interfaces may be used to view drive/folder/file type views of the storage devices and allow selection of one or more files to be included in the package file.

The publication module 712, in some embodiments, is operative to receive input specifying how to perform one or more functions with an authored package file. The one or more functions may include saving and/or distributing the package file. These functions may be accomplished through one or more, or a combination of, a save module 714, an email module 716, and a document center module 718.

The save module 714 is operative to present a user interface to save a package file to a storage device, such as the storage device 720. In some embodiments, the save module 714 leverages one or more functions of a host application, such as application 600 of FIG. 6, to store the package file. Such functions may include displaying a user interface providing a drive/folder/type view to receive input specifying where the package file is to be stored.

The email module 716, in some embodiments, is operative to call an email client present on a computing device upon which the package editing module 700 is operating to attach the package file to an email, which may then be addressed and sent using the email client. In some embodiments, an email client may be present within the email module or may be included within the application 600 of FIG. 6. In such embodiments, one or a series of user interfaces may be provided to receive one or more email address of intended recipients, a message, and the package file. The received input may then be sent via email utilizing a default email server or an email server identified in a configuration setting.

The document center module 718, in some embodiments, is operative to publish package files to a location where one or more users may access the document. The location may be a collaboration server. In some such embodiments, the document center module 718 is operative to instantiate a collaboration session on a collaboration server and embeds an identifier of the instantiated collaboration session within the package file. The package file may then be stored on the collaboration server. In some such embodiments, one or more user interfaces may also be provided to a user to select or enter one or more other users to receive a notification of the instantiated collaboration session. In some other embodiments, after the collaboration session identifier is embedded within the package file, the package file may then be distributed via the email module 716 and/or stored using the save module 714. In these embodiments, when other users open the package file, the application within which the package file is viewed, such as a page description language reading application, may connect to the collaboration server and download comments and other data and display a representation of some or all of the downloaded data within the package file. The page description language reading application may also allow a viewer of the package file to enter comments or perform other actions, such as approving, and store data representative of the actions or of the comments to the collaboration server for other users or processes to see and use.

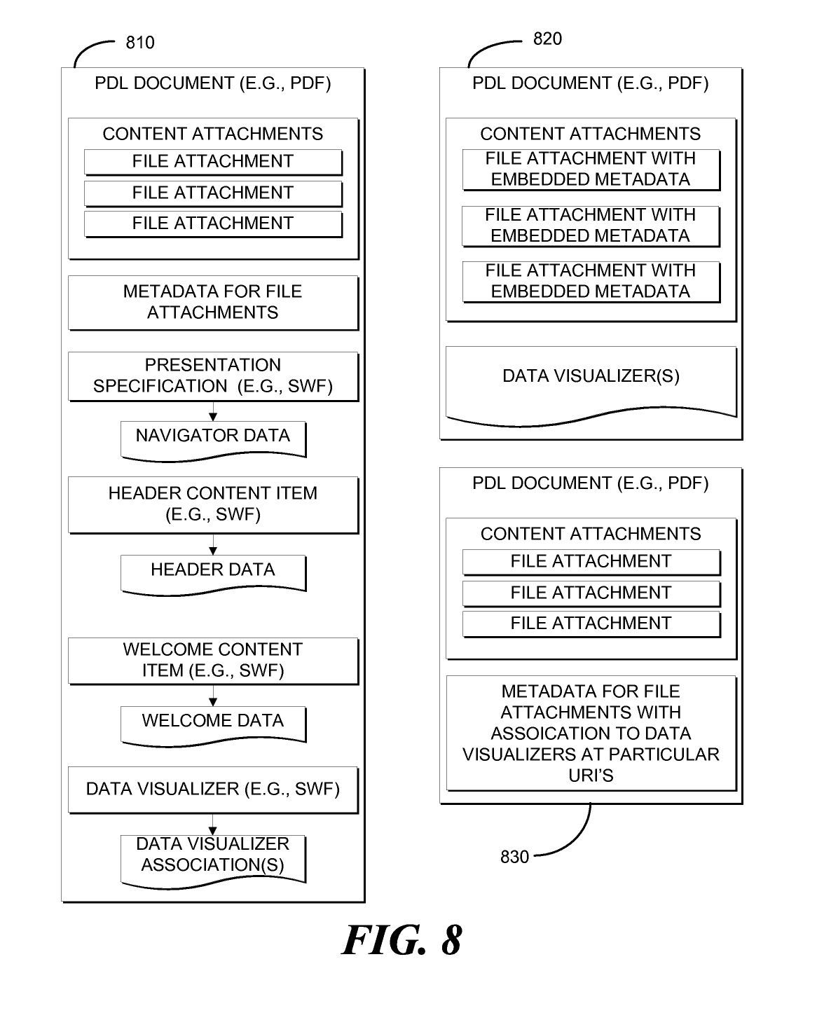

FIG. 8 includes block diagrams of various page description language documents 810, 820, 830, according to example embodiments. While the example embodiment is described in the context of page description language documents, it will be appreciated that other embodiments may be implemented using other types of documents and content files. Each of the illustrated page description language documents 810, 820, 830 is slightly different from the others. The form of page description language documents, when taking the form of a package file, may vary from embodiment to embodiment based on the nature of the one or more presentation specifications utilized in presenting the package file and data visualizers utilized in presenting content files. Further, in some embodiments, such as in the page description language document 820, the presentation specification is not even included in the page description language document 820, but instead is referenced in the package file presentation metadata. Similarly, in some embodiments, such as in the page description language document 830, data visualizers are not even included in the page description language document 830, but instead are referenced in package file metadata.

A first page description language document 810 includes content attachments, such as one or more content file attachments and metadata for each of the one or more file attachments. The page description language document 810 further includes a presentation specification and navigator data for use by the presentation specification in presenting one or more views of the page description language document 810. The page description language document 810 further includes a header content item and header data defining how the header content item is to be displayed. The page description language document 810 also includes a welcome content item and welcome data defining how the welcome content item is to be displayed. A welcome content item is generally a first view of the page description language document 810 displayed when the page description language document 810 is first opened. A displayed welcome content item may be thought of as a “splash screen” in some embodiments. The page description language document 810 also includes at least one data visualizer and metadata associating a content file attachment to a data visualizer to be used in presenting a view of the associated content file attachment. Although the data visualizer associations are illustrated in the first page description language document 810 with the at least one data visualizer, the data visualizer associations may instead be specified in the metadata for file attachments, or elsewhere within the first page description language document 810.

A second page description language document 820 takes a different form from that of the first page description language document 810. The second page description language document 820 includes one or more file attachments, and each file attachment includes embedded metadata. The page description language document 820 may further include package file presentation metadata including a reference to at least a presentation specification and metadata of how the presentation specification is to be instantiated and presented. When the page description language document 820 is opened, a suitable application for presenting a view of the page description language document 820 may identify that there is a reference to a presentation specification and obtain a copy thereof from a referenced location, such as an Internet or other network location, by download. The application for presenting the view of the page description language document 820 may then extract the metadata embedded in each of the file attachments. The extracted metadata for a particular file attachment may include metadata associating the file attachment to a particular data visualizer also included in the second page description language document 820. The presentation specification is then instantiated as a function of the package file presentation metadata and the extracted file attachment metadata. When a file attachment is selected within a view of the second page description language document 820 provided according to the presentation specification, the selected file attachment will be presented according to the associated data visualizer as specified in the metadata of the selected file attachment.

A third page description language document 830 takes yet another form. The page description language document 830 includes one or more file attachments and metadata for each file attachment. The page description language document 830 in this instance does not include a presentation specification. In such an instance, the third page description language document 830, when presented for viewing, may simply be presented as a listing of the attached files. However, the third page description language document 830 does include metadata for the file attachments with associations to data visualizers and a URI for each data visualizer. The URI specifies a network location from which the data visualizer may be downloaded. When a file attachment is selected for viewing, the metadata is accessed to identify the data visualizer and the location where it may be downloaded. The data visualizer is then downloaded and utilized in presenting a view of the selected file attachment.

Each of the page description language documents 810, 820, 830 includes a different form as described and illustrated. This is not intended to be a listing of all forms that page description language documents that are package files may take. Instead, the embodiments in FIG. 8 are examples as to the flexible nature of package files, presentation specifications, and data visualizers.

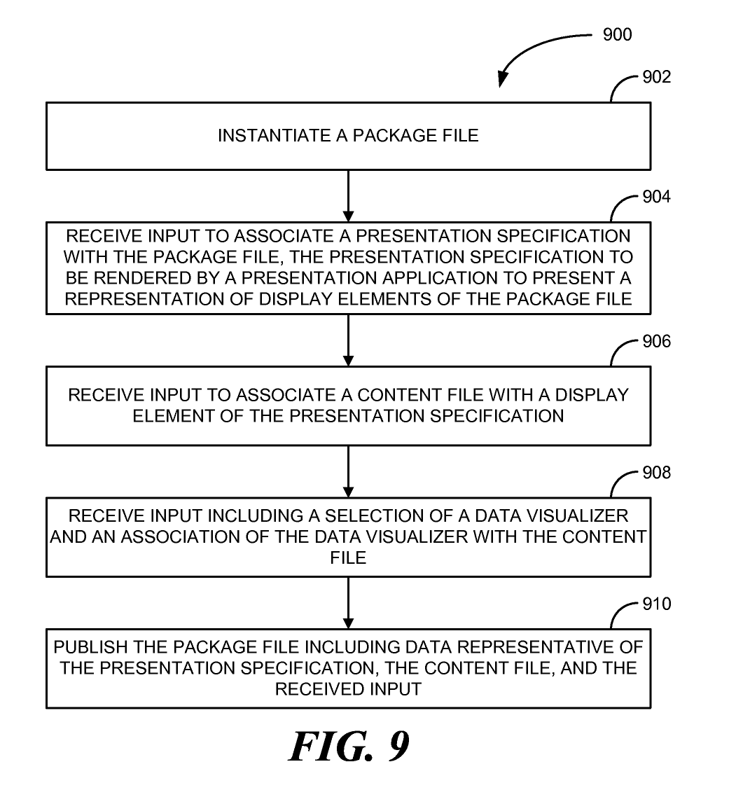

FIG. 9 is a flow diagram of a method 900, according to an example embodiment. The method 900 is an example of a method that may be performed to author a package file. The method 900 may be performed by an authoring module of a package file application including authoring functionality, such as package editing module 602 of the application 600 illustrated and described with regard to FIG. 6, and the package editing module 700 illustrated and described with regard to FIG. 7. The method 900 is typically in the form of a set of instructions stored on a data storage device. The instructions are retrieved into a memory device of a computer for execution by at least one processor of the computer to cause the computer to perform the method 900.

In some embodiments, the method 900 includes instantiating 902, a package file, such as by generating a shell of a data structure in the memory device. The method 900 further includes receiving 904 input to associate a presentation specification with the package file, the presentation specification to be rendered by a presentation application to present a representation of display elements of the package file. The method 900 also includes receiving 906 input to associate a content file with a display element of the presentation specification and receiving 908 input including a selection of a data visualizer and an association of the data visualizer with the content file. The method 900 may then conclude by publishing 910 the package file including data representative of the presentation specification, the content file, and the received input.

In some embodiments, publishing 910 the package file includes adding the content file, the presentation specification, the display elements, and the association of the display element to the content file, to the package file. Publishing 910 the package file may also include adding the data visualizer and the association of the data visualizer to the content file within the package file. In other embodiments, rather than adding the data visualizer to the content file, the publishing 910 of the package file includes adding a URI, such as a URL or other network address, of a network location from which the data visualizer is downloadable to the package file. Regardless of whether the data visualizer is directly added to the package file or added by reference to a URI; the publishing 910 of the package file may further include one or more additional actions. These one or more additional actions of publishing 910 the package file may include storing the package file, such as through the save module 714 of FIG. 7, and emailing the package file such as through the email module 716 of FIG. 7. The one or more additional actions of publishing 910 the package file may also include publishing package files to a location where one or more users may access the document, such as on a collaboration server, such as through the document center module 718 of FIG. 7.

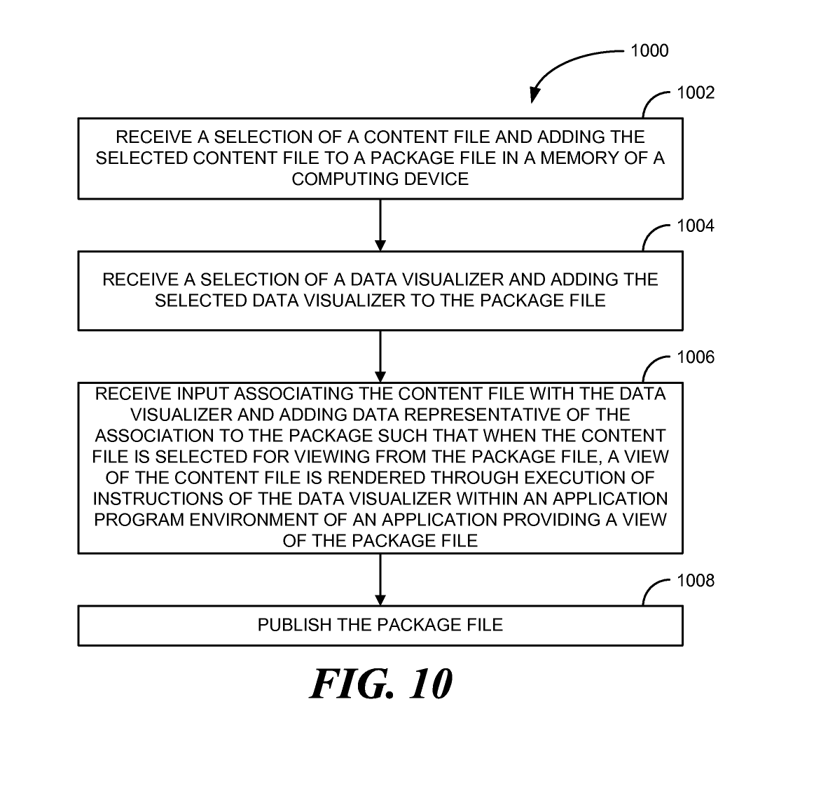

FIG. 10 is a flow diagram of a method 1000, according to an example embodiment. The method 1000 is another example of a method that may be performed to author a package file. As with the method 900 of FIG. 9, the method 1000 may also be performed by an authoring module of a package file application including authoring functionality, such as package editing module 602 of the application 600 illustrated and described with regard to FIG. 6, and the package editing module 700 illustrated and described with regard to FIG. 7. The method 1000 is typically in the form of a set of instructions stored on a data storage device of a computing device. The instructions of the set of instructions are executable by at least one processor of the computing device to cause the computing device to perform the method 1000.

In some embodiments, the method 1000 includes receiving 1002 a selection of a content file, such as within a user interface, and adding the selected content file to a package file in a memory of a computing device. The method 1000 further includes receiving 1004 a selection of a data visualizer and adding the selected data visualizer to the package file in the memory of the computing device. In some embodiments of the method 1000, adding of the data visualizer to the package file includes storing the data visualizer to a network storage location from which the data visualizer is downloadable and adding a URI to the package file of the network location from which the data visualizer is downloadable. In other embodiments, adding the data visualizer to the package file includes adding the data of the data visualizer within the package file in the memory of the computing device.

In some embodiments of the method 1000, the package file is a page description language document and the content file is a data type other than a page description language document. For example, the content file may be a word processing document, a spreadsheet program file, an audio/visual file, a presentation program (e.g., Microsoft Power Point) file, a delimited file (e.g., a comma or tab delimited file), or other file types.

The method 1000 additionally includes receiving 1006 input associating the content file with the data visualizer and adding data representative of the association to the package file in the memory of the computing device. Through the association of the content file to the data visualizer, when the content file is selected for viewing from the package file, a view of the content file is rendered through execution of instructions of the data visualizer within an application program environment of an application providing a view of the package file. The method 1000 further includes publishing 1008 the package file. Publishing 1008 the package file may include storing the package file on a data storage device either locally to the computing device performing the method 1000 or remotely over a network to a network data storage device or data storage device of another computing device.

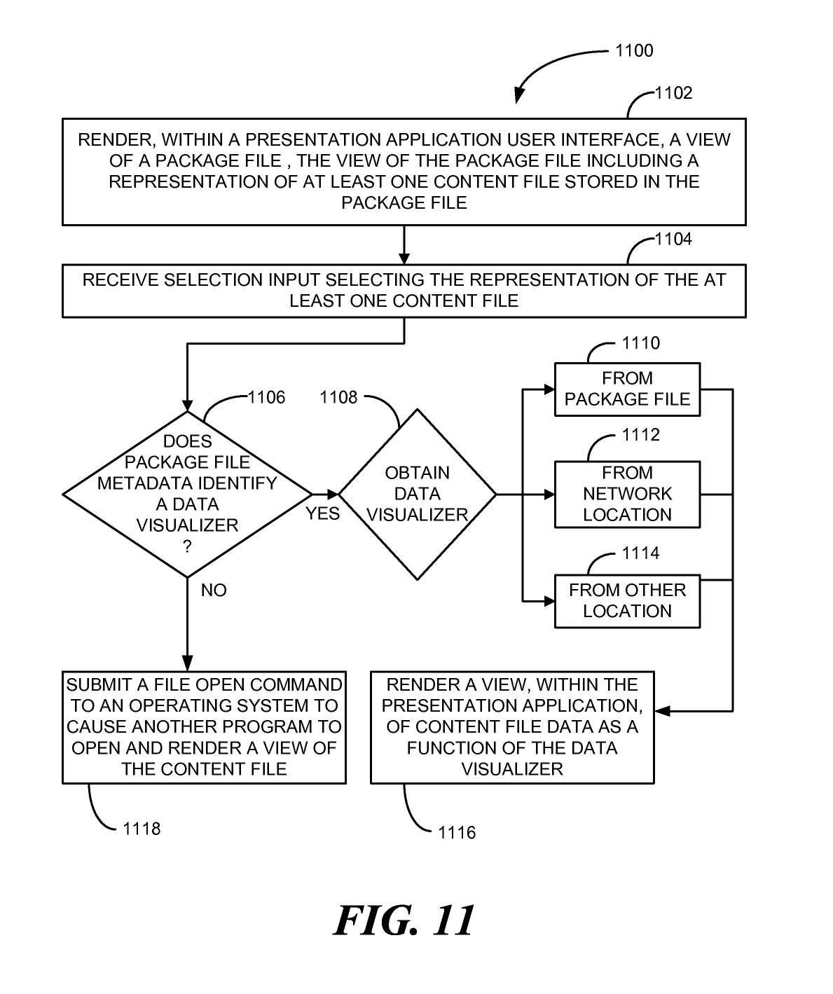

FIG. 11 is a flow diagram of a method 1100, according to an example embodiment. The method 1100 is an example of a method that may be performed to generate a view of a package file. The method 1100 may be performed by a presentation module of a package file reading application, such as an application including at least the packages host module 614 of the application 600 illustrated and described with regard to FIG. 6. The method 1100 is typically in the form of a set of instructions stored on a data storage device of a computing device. The set of instructions is executable by at least one processor of the computing device to cause the computing device to perform the method 1100.

In some embodiments, the method 1100 includes rendering 1102, within a presentation application user interface on a display device of a computing device, a view of a package file including a representation of at least one content file stored in the package file, and receiving 1104 selection input selecting the representation of the at least one content file. The method 1100 further includes determining 1106, according to metadata stored within the package file, if a view of the content file is to be generated utilizing a data visualizer identified in the metadata.

When the determination 1106 is that the view of the content file is not to be generated utilizing a data visualizer identified in the meta data, the method 1100 includes submitting 1118 a file open command to an operating system to cause another program to open and render a view of the content file. For example, when the content file is a word processing document, the command may pass a memory reference to a copy of the content file with a file open command to the operating system. The operating system will then open the file with a word processing program associated with a file type of the content file and render a view of the content file.

When the determination 1106 is that the view of the content file is to be generated utilizing a data visualizer identified in the meta data, the method 1100 includes submitting a file open command to an operating system of the computing device performing the method 1100. The submitted file open command will cause the operating system to identify another program associated with a file type of the content file. The operating system will then cause the identified program to open and render a view of the content file.

When the view of the content is to be generated utilizing a data visualizer identified in the metadata, the method 1100 includes determining 1108 where the data visualizer can be obtained from according to the metadata and retrieving the identified data visualizer from the determined location. The determined location may be one of the package file 1110, a network location 1112, or another location 1114, such as embedded within a presentation specification. Once the data visualizer is retrieved, the method 1100 includes rendering 1116 a view, within the presentation application, of content file data as a function of the data visualizer.

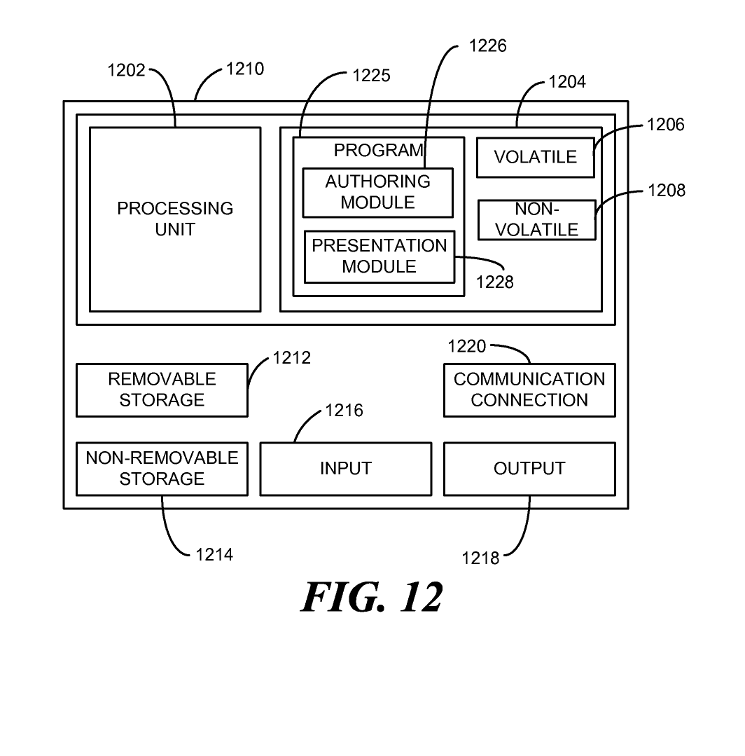

FIG. 12 is a block diagram of a computing device capable of executing instructions to perform one or more of the methods described according to the example embodiments herein. In one embodiment, multiple such computer systems are utilized in a distributed network to implement multiple components in a transaction-based environment. An object-oriented, service-oriented, or other architecture may be used to implement such functions and communicate between the multiple systems and components. One example computing device, in the form of a computer 1210, may include various devices that are communicatively coupled via a bus. The various components in the computer 1210 include at least one processing unit 1202, memory 1204, removable storage 1212, and non-removable storage 1214. Memory 1204 may include volatile memory 1206 and non-volatile memory 1208. Computer 1210 may include—or have access to a computing environment that includes—a variety of computer-readable mediums, such as volatile memory 1206 and non-volatile memory 1208, removable storage 1212 and non-removable storage 1214. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1210 may include or have access to a computing environment that includes input 1216, output 1218, and a communication connection 1220. The computer 1210 may operate in a networked environment using a communication connection to connect to one or more remote computers, such as database servers, which may store one or more data visualizers. The remote computer may include a personal computer (PC), server, router, network PC, a peer device or other common network node, or the like. The communication connection 1220 may include a Local Area Network (LAN), a Wide Area Network (WAN) or other networks.

Computer-readable instructions stored on a computer-readable medium are executable by the at least one processing unit 1202 of the computer 1210. A hard drive, CD-ROM, and RAM are some examples of articles including a computer-readable medium that may store computer-readable instructions. For example, a computer program 1225 including one or both of an authoring module 1226 and a presentation module 1228 as described above may be stored in the memory 1204. The instructions of the computer program 1225 are retrievable for execution by the at least one processing unit 1202.

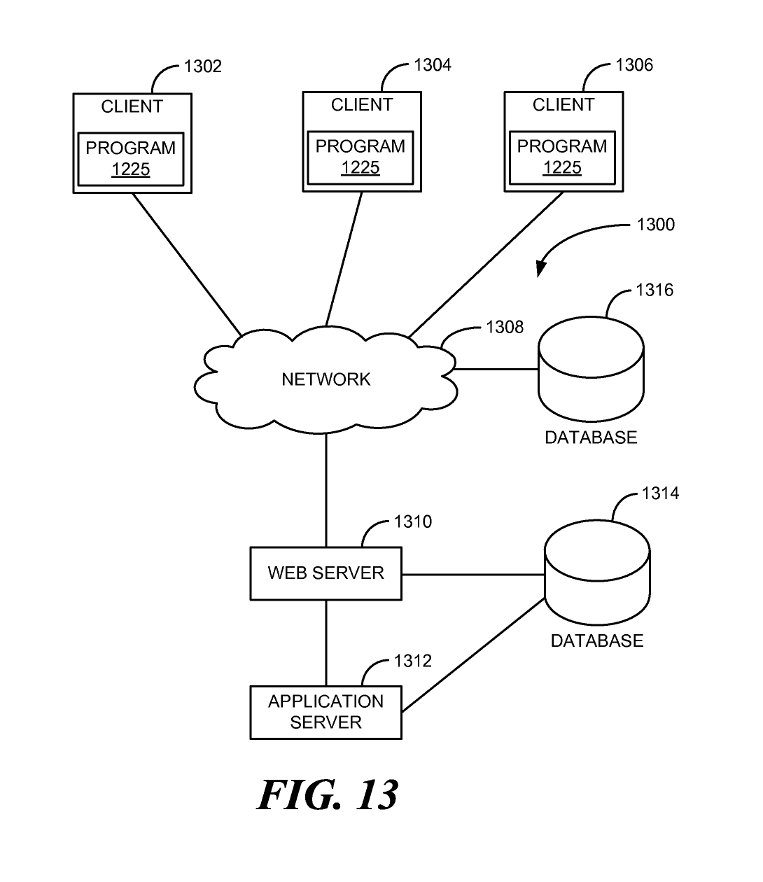

FIG. 13 is a logical diagram of a computing environment 1300 according to an example embodiment. The computing environment 1300 is an example of a networked computing environment within which the various embodiments may operate. The computing environment 1300 includes client computing devices 1302, 1304, 1306. Each of the client computing devices 1302, 1304, 1306 includes the computer program 1225 as illustrated and described with regard to FIG. 12. Although the computer program 1225 on each of the client computing devices 1302, 1304, 1306 is illustrated as the same computer program 1225, the client computing devices 1302, 1304, 1306 may instead have differing computer programs. For example, the computer program 1225 on the client computing devices 1302, 1304, 1306 may be different versions (e.g., 10.0, 10.1, 11.3, etc.) of the same computer program, different editions (e.g., basic, standard, professional, extreme, etc.) of computer programs in a computer program family, or different computer programs providing compatible functionality.

In computing environment, each of the client computing devices 1302, 1304, 1306 is connected to a network 1308, such as one or more of a Local Area Network, the Internet, and other network types. The network 1308 may facilitate communication between the client computing devices 1302, 1304, 1306 and other computing and data storage resources, such as a web server 1310, an application server 1312, and databases 1314, 1316.

In operation, the computer program 1225 on one of the client computing devices 1302, 1304, 1306 may receive a selection of a content item included in a package file. Metadata of the package file may associate the content item to a URI from which a data visualizer can be downloaded. That URI may identify a location, such as in one of the databases 1314, 1316, the web server 1310, or a process that executes on the application server 1312 to construct the data visualizer on demand. In such an instance, the computer program 1225 of the particular client computing device 1302, 1304, 1306 communicates over the network 1308 to the resource identified by the URI to retrieve the data visualizer.

In some embodiments, the web server 1310 and application server 1312 may, individually or in cooperation, provide collaboration server functionality. In such embodiments, package files may be published by the computer program 1225 of a client computing device 1302, 1304, 1306 to one or both of the web server 1310 and application server 1312 and stored on the database 1314 for hosted or facilitated collaboration sessions. The package file may be published by a document center module 718 as illustrated and described with regard to FIG. 7 that may be included within the computer program 1225 of a client computing device 1302, 1304, 1306.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A system comprising:
a hardware memory;
at least one hardware processor;
an authoring module stored in the hardware memory and executable on the at least one hardware processor to perform actions comprising:
instantiating a package file;
receiving a first input to associate a presentation specification with the package file, the presentation specification to be rendered by a presentation application to present a representation of display elements of the package file;
receiving a second input to associate a content file with a display element of the presentation specification;
receiving a third input including a selection of a data visualizer and an association of the data visualizer with the content file, the data visualizer to be instantiated within one of an application or application plug-in to present a view of the content file associated therewith, the data visualizer including executable code to implement functionality and customize presentation of the content file; and
publishing the package file including data representative of the presentation specification, the content file, and the received first, second, and third inputs.

2. The system of claim 1, wherein the data visualizer includes instructions executable by the at least one hardware processor to render a view of the content file within the presentation application.

3. The system of claim 1, further comprising:
a presentation module stored in the hardware memory and executable on the at least one hardware processor to perform actions comprising:
presenting a view of the package file, the view to be generated as a function of the presentation specification and the second input associating the content file with the display element of the presentation specification;
receiving input selecting the display element associated with the content file; and
rendering a view of the content the as a function of the data visualizer.

4. The system of claim 1, wherein publishing the package file includes:
adding within the package file:
the content file,
the presentation specification,
the display elements and the association of the display element to the content file, and
the data visualizer and the association of the data visualizer to the content file; and
storing the package file.

5. The system of claim 4, wherein adding the data visualizer to the package file includes:
storing the data visualizer to a network location from which the data visualizer is downloadable; and
adding to the package file a Universal Resource Identifier (URI) of the network location from which the data visualizer is downloadable.

6. The system of claim 1, wherein publishing the package file includes:
adding the content file, the presentation specification, the display elements and the association of the display element to the content file, a Universal Resource Identifier (URI) of a network location from which the data visualizer is downloadable, and the association of the data visualizer to the content file; and
storing the package file.

7. The system of claim 1, wherein:
the package file is a page description language document; and
the content file is a data type other than a page description language document.

8. A method comprising:
receiving a first selection of a content file and adding the selected content file to a package file in a memory of a computing device;
receiving a second selection of a data visualizer and adding the selected data visualizer to the package file;
receiving input associating the content file with the data visualizer and adding data representative of the association to the package file such that when the content file is selected for viewing from the package file, a view of the content file is rendered through:
instantiation of the data visualizer within an application program environment an application providing a view of the package file, the data visualizer including executable code to implement functionality and customize presentation of the content file; and
execution of instructions of the data visualizer within the application program environment of the application providing the view of the package file; and
executing instructions on at least one processor of the computing device to publish the package file.

9. The method of claim 8, wherein the data visualizer includes instructions executable to render the view of the content file within a presentation application.

10. The method of claim 8, wherein, within a presentation application, upon receipt of selection input selecting a representation of the content file, calls executable instructions of the data visualizer to render the view of the content file.

11. The method of claim 8, wherein executing instructions on the at least one processor of the computing device to publish the package file includes executing instructions to:
store the package file on a data storage device of the computing device.

12. The method of claim 8, wherein the adding of the data visualizer to the package file includes:
storing the data visualizer to a network storage location from which the data visualizer is downloadable; and
adding a Universal Resource Identifier (URI) to the package file of the network location from which the data visualizer is downloadable.

13. The method of claim 8, wherein the adding of the data visualizer to the package file includes:
adding a Universal Resource Identifier (URI) of a network location from which the data visualizer is downloadable.

14. The method of claim 8 wherein:
the package file is a page description language document; and
the content file is a data type other than a page description language document.

15. A no transitory computer-readable storage medium, with instructions stored thereon, which when executed by at least one processor of a computer, cause the computer to perform a method comprising:
rendering, within a presentation application user interface on a display device of the computer, a view of a package file including a representation of a plurality of content files stored in the package file;
receiving selection input selecting a representation of the one content file of the plurality of content files stored in the package file;
determining, according to metadata stored within the package file, that a view of the selected content file is to be generated utilizing a data visualizer identified in the metadata, the data visualizer to be instantiated within one of the presentation application and an application plug-in of the presentation application to present a view of the selected content file associated therewith, the data visualizer including executable code to implement functionality and customize presentation of the selected content file, and the metadata associating the data visualizer to the selected content file and at least one other content file;
retrieving the data visualizer identified in the metadata; and
rendering a view, within the one of the presentation application and the application plug-in of the presentation application, of content file data as a function of the data visualizer.

16. The non-transitory computer-readable storage medium of claim 15, wherein the data visualizer identified in the metadata is identified by data including a Universal Resource Identifier (URI) of a network location from which the data visualizer is downloadable.

17. The non-transitory computer-readable storage medium of claim 16, wherein retrieving the data visualizer identified in the metadata includes downloading the data visualizer from the network location identified by the URI.

18. The non-transitory computer-readable storage medium of claim 15, wherein the package file is a page description language document.

19. The non-transitory computer-readable storage medium of claim 18, wherein the selected content file is not a page description language document.

20. The non-transitory computer-readable storage medium of claim 15, the method further comprising:
receiving an additional selection input selecting a representation of a second content file of the plurality of content files;
determining, according to metadata stored within the package file, that the metadata does not identify a data visualizer to be utilized in generating a view of the second content file; and
submitting a file open command to an operating system of the computer to cause another program on the computer to open and render a view of the data within the second content file.
